(19) United States
(12) Patent Application Publication
(10) Pub. No.: US 2023/0178294 A1
(43) Pub. Date: Jun. 8, 2023

(54) MULTILAYER COIL COMPONENT

(71) Applicant: Murata Manufacturing Co., Ltd., Kyoto-fu (JP)

(72) Inventors: Takahiro OGOSHI, Nagaokakyo-shi (JP); Minoru MATSUNAGA, Nagaokakyo-shi (JP)

(73) Assignee: Murata Manufacturing Co., Ltd., Kyoto-fu (JP)

(21) Appl. No.: 18/060,502

(22) Filed: Nov. 30, 2022

(30) Foreign Application Priority Data
Dec. 3, 2021 (JP) 2021-197166

(51) Int. Cl. H01F 27/32; H01F 27/24

(52) U.S. Cl. CPC H01F 27/323; H01F 27/24

(57) ABSTRACT

In a multilayer coil component, a multilayer body includes a plurality of insulator layers and a through-hole. The through-hole penetrates in a third positive direction. A first coil extends inside the multilayer body while surrounding an outer circumference of the through-hole. A magnetic resin is filled into the through-hole. An overlying adhesive resin layer is laminated on a first surface of the multilayer body. An upper magnetic substrate is adhered to the multilayer body with the overlying adhesive resin layer interposed therebetween. The overlying adhesive resin layer includes an accommodation space. The accommodation space is connected to the through-hole. When the multilayer coil component is seen in the third positive direction, an outer edge of the accommodation space is located on an outer side of an outer edge of the through-hole. A portion of the magnetic resin is located inside the accommodation space.

### CROSS-REFERENCE TO RELATED APPLICATION

This application claims benefit of priority to Japanese Patent Application No. 2021-197166, filed Dec. 3, 2021, the entire content of which is incorporated herein by reference.

### BACKGROUND

### Technical Field

The present disclosure relates to a multilayer coil component.

### Background Art

A multilayer coil component described in Japanese Unexamined Patent Application Publication No. 2010-80594 includes a multilayer body, a coil, and a magnetic resin. The multilayer body includes a plurality of insulator layers. The plurality of insulator layers are laminated in a laminating direction. The multilayer body has a through-hole penetrating in the laminating direction in a quadrangular pillar shape. The coil extends in a helical shape so as to surround the through-hole from outside in the multilayer body. The inside of the through-hole is filled up with the magnetic resin. Therefore, the magnetic resin has a substantially quadrangular pillar shape reflecting the shape of the through-hole. Further, the multilayer coil component includes two magnetic substrates. The two magnetic substrates sandwich the multilayer body respectively from the opposite directions in the laminating direction.

### SUMMARY

In the multilayer coil component described in Japanese Unexamined Patent Application Publication No. 2010-80594, during the process of filling up the inside of the through-hole with the magnetic resin, it is difficult to fill up the entire range of the through-hole with the magnetic resin, and an unfilled space remains inside the through-hole. When a large unfilled space exists inside the through-hole, an amount of magnetic resin is reduced by the amount of unfilled space, which may adversely affect characteristics of the multilayer coil component.

Accordingly, the present disclosure provides a multilayer coil component including a multilayer body including a plurality of insulator layers laminated in a laminating direction and a through-hole penetrating the plurality of insulator layers in the laminating direction; a coil extending inside the multilayer body while surrounding an outer circumference of the through-hole; a magnetic resin including resin and magnetic material and filled into the through-hole; an adhesive resin layer laminated on a surface facing to the laminating direction of an outer surface of the multilayer body; and a magnetic substrate adhered to the multilayer body with the adhesive resin layer interposed therebetween. The adhesive resin layer includes an accommodation space connected to the through-hole. An outer edge of the accommodation space is located on an outer side of an outer edge of the through-hole when seen in the laminating direction. A portion of the magnetic resin is located inside the accommodation space.

According to the configuration described above, during the manufacturing process of the multilayer coil component, the accommodation space of the adhesive resin layer can function as a space to which the magnetic resin filled into the through-hole escapes. That is, a filling amount of magnetic resin can be set to, at the maximum, an amount obtained by adding a volume of the through-hole and a volume of the accommodation space. Therefore, even when variations in the filling amount of magnetic resin occur due to an error or the like in the manufacturing, the filling amount of magnetic resin is unlikely to fall below the volume of the through-hole. As a result, a possibility that the magnetic resin spreads over the entire through-hole becomes higher.

It becomes easier to fill the magnetic resin into the entire through-hole.

### BRIEF DESCRIPTION OF THE DRAWINGS

FIG. 1 is a perspective view of a multilayer coil component according to one embodiment;

FIG. 2 is a perspective view of the multilayer coil component according to the embodiment;

FIG. 3 is an exploded perspective view of the multilayer coil component according to the embodiment;

FIG. 4 is a plan view of a second layer L2 of the embodiment;

FIG. 5 is a sectional view of the multilayer coil component taken along Line 5-5 illustrated in FIG. 4;

FIG. 6 is a sectional view of a multilayer coil component of a modification;

FIG. 7 is a sectional view of a multilayer coil component of another modification; and

FIG. 8 is a sectional view of a multilayer coil component of still another modification.

### DETAILED DESCRIPTION

### Embodiment

Hereinafter, one embodiment of a multilayer coil component is described. Note that components illustrated in the drawings may be enlarged to facilitate understanding. Further, dimensional ratios of the components may be different from the actual ratios or from the ratios indicated in the other drawings.

### Overall Configuration

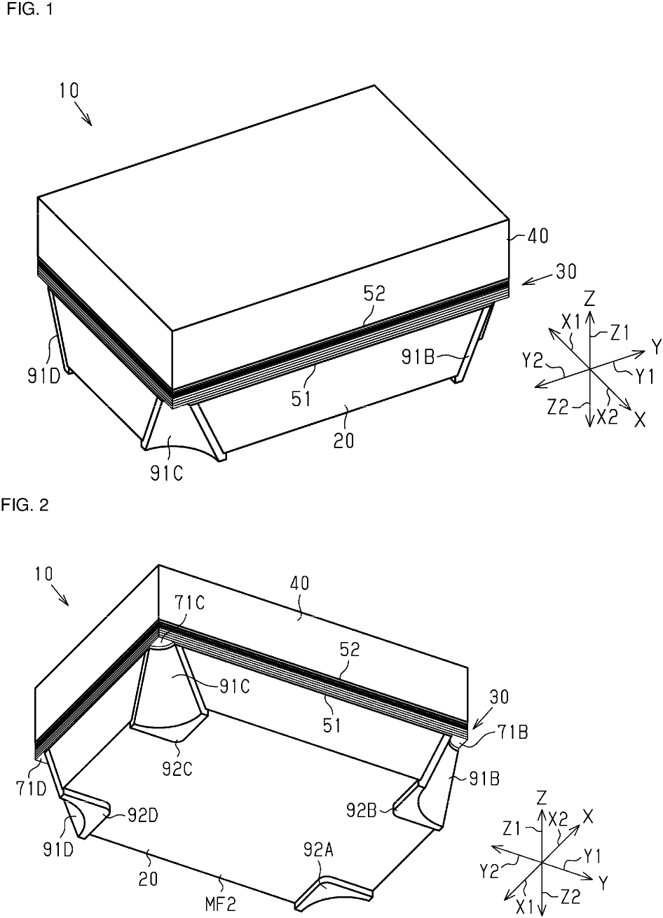

As illustrated in FIG. 1, a multilayer coil component 10 includes a lower magnetic substrate 20, an underlying adhesive resin layer 51, a multilayer body 30, an overlying adhesive resin layer 52, and an upper magnetic substrate 40. The lower magnetic substrate 20, the underlying adhesive resin layer 51, the multilayer body 30, the overlying adhesive resin layer 52, and the upper magnetic substrate 40 are laminated in this order in a laminating direction. Further, the multilayer coil component 10 includes a magnetic resin 56 in addition to the laminated components described above.

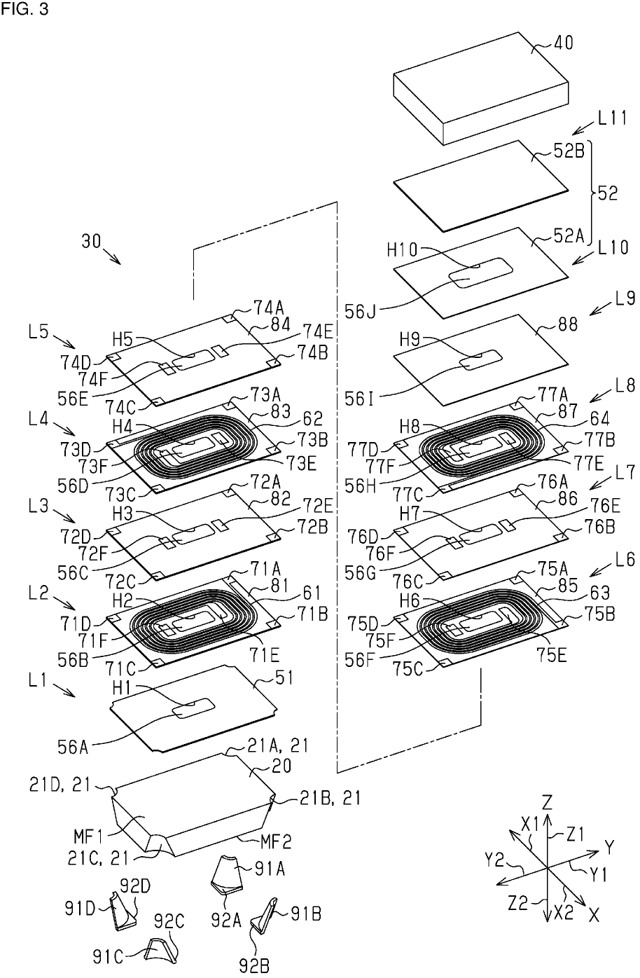

As illustrated in FIG. 3, the lower magnetic substrate 20 has a substantially rectangular parallelepiped shape. The lower magnetic substrate 20 has a first principal surface MF1. The first principal surface MF1 is a surface having the largest area among flat surfaces constituting an outer surface of the lower magnetic substrate 20. Further, as illustrated in FIG. 2, the lower magnetic substrate 20 has a second principal surface MF2. The second principal surface MF2 is in parallel to the first principal surface MF1.

As illustrated in FIG. 3, when the lower magnetic substrate 20 is seen in a direction perpendicular to the first principal surface MF1, the lower magnetic substrate 20 has a substantially rectangular shape with four corners cut out like notches. Therefore, the lower magnetic substrate 20 has four linear sides when seen in the direction perpendicular to the first principal surface MF1. In the following description, when the lower magnetic substrate 20 is seen in the direction perpendicular to the first principal surface MF1, an axis parallel to one specific side of the four sides is referred to as a first axis X. Further, when the lower magnetic substrate 20 is seen in the direction perpendicular to the first principal surface MF1, an axis perpendicular to the first axis X is referred to as a second axis Y Moreover, an axis perpendicular to the first principal surface MF1 is referred to as a third axis Z. Further, one of directions parallel to the first axis X is referred to as a first positive direction X1, and a direction opposite from the first positive direction X1 in the first axis X direction is referred to as a first negative direction X2. Further, one of directions along the second axis Y is referred to as a second positive direction Y1, and a direction opposite from the second positive direction Y1 in the second axis Y direction is referred to as a second negative direction Y2. Further, a direction to which the first principal surface MF1 faces of directions along the third axis Z is referred to as a third positive direction Z1, and a direction opposite from the third positive direction Z1 is referred to as a third negative direction Z2. Note that the third positive direction Z1 is the laminating direction.

A dimension of the lower magnetic substrate 20 in the second axis Y direction is larger than a dimension thereof in the first axis X direction. That is, each of the first principal surface MF1 and the second principal surface MF2 of the lower magnetic substrate 20 has, as a whole, a rectangular shape longer in the second axis Y direction. The lower magnetic substrate 20 is made of magnetic material. The magnetic material is, for example, a sintered body of ferrite ceramics.

The lower magnetic substrate 20 has four notches 21A to 21D connecting the first principal surface MF1 to the second principal surface MF2. The notch 21 exists at each of the four corners when the lower magnetic substrate 20 is seen in third positive direction Z1. That is, the notches 21 are space existing at the four corners of the lower magnetic substrate 20. Further, when the lower magnetic substrate 20 is seen in the third positive direction Z1, an area of each notch 21 becomes smaller as approaching from the second principal surface MF2 to the first principal surface MF1. Note that the four notches 21A to 21D are referred to below as the notch 21 when they are not distinguished.

The notch 21A is located at a corner on the first positive direction X1 side and the second positive direction Y1 side when seen from the center of the lower magnetic substrate 20. The notch 21B is located at a corner on the first negative direction X2 side and the second positive direction Y1 side when seen from the center of the lower magnetic substrate 20. The notch 21C is located at a corner on the first negative direction X2 side and the second negative direction Y2 side when seen from the center of the lower magnetic substrate 20. The notch 21D is located at a corner on the first positive direction X1 side and the second negative direction Y2 side when seen from the center of the lower magnetic substrate 20.

As illustrated in FIG. 3, the multilayer coil component 10 has a layered structure constituted of first to eleventh layers L1 to L11 on the third positive direction Z1 side with respect to the lower magnetic substrate 20. Principal surfaces of each layer are in parallel to the first principal surface MF1 of the lower magnetic substrate 20. The first to eleventh layers L1 to L11 are arranged in this order in the third positive direction Z1.

The first layer L1 includes the underlying adhesive resin layer 51 and a first magnetic part 56A. The underlying adhesive resin layer 51 is made of an organic adhesive such as a polyimide resin. When the first layer L1 is seen in the third negative direction Z2, the first layer L1 covers a substantial portion of the first principal surface MF1 of the lower magnetic substrate 20. Therefore, when the first layer L1 is seen in the third negative direction Z2, the first layer L1 has a substantially rectangular shape with four corners cut out like notches, similarly to the lower magnetic substrate 20.

The underlying adhesive resin layer 51 has a hole H1 penetrating in the third axis Z direction. The hole H1 has a quadrilateral shape when the underlying adhesive resin layer 51 is seen in the third positive direction Z1. The hole H1 is located substantially at the center of the rectangular shape of the underlying adhesive resin layer 51 when the underlying adhesive resin layer 51 is seen in the third negative direction Z2.

The first magnetic part 56A is located inside the hole H1. The first magnetic part 56A fills the internal space of the hole H1. Material of the first magnetic part 56A is resin and magnetic material. Specifically, the resin is an epoxy resin. The magnetic material is magnetic metal powder such as magnetic powder constituted of ferrite powder and iron.

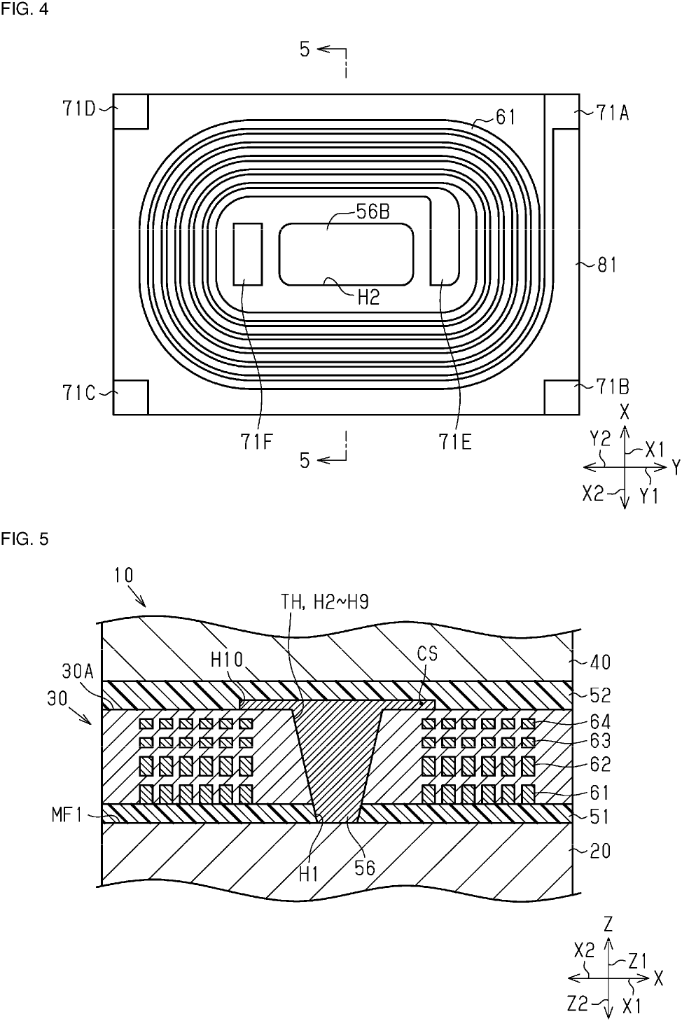

As illustrated in FIG. 4, the second layer L2 includes a first coil 61, six extended portions 71A to 71F, a first insulator layer 81, and a second magnetic part 56B. When the second layer L2 is seen in the third negative direction Z2, the second layer L2 has a rectangular shape whose dimensions in the first axis X direction and the second axis Y direction are the same as those of the first layer L1. Note that the second layer L2 has a shape without notches at corners, unlikely to the first layer L1. A thickness of the second layer L2 is, for example, 9 µm or larger and 11 µm or smaller.

The extended portion 71A is located at a corner of the second layer L2 on the first positive direction X1 side and the second positive direction Y1 side. The extended portion 71B is located at a corner of the second layer L2 on the first negative direction X2 side and the second positive direction Y1 side. The extended portion 71C is located at a corner of the second layer L2 on the first negative direction X2 side and the second negative direction Y2 side. The extended portion 71D is located at a corner of the second layer L2 on the first positive direction X1 side and the second negative direction Y2 side. The extended portion 71E is located on the second positive direction Y1 side with respect to the center of the second layer L2 and at the center in the first axis X direction. The extended portion 71F is located on the second negative direction Y2 side with respect to the center of the second layer L2 and at the center in the first axis X direction. The extended portions 71A to 71F are made of conductive material such as copper and silver.

When the second layer L2 is seen in the third negative direction Z2, the first coil 61 extends, as a whole, in a spiral shape centering on the center of the second layer L2. A first end of the first coil 61 is connected to the extended portion 71A. A second end of the first coil 61 is connected to the extended portion 71E. When the second layer L2 is seen in the third negative direction Z2, the first coil 61 is wound clockwisely from the first end to the second end. The first coil 61 is made of conductive material such as copper and silver. In this embodiment, the first coil 61 is made of conductive material same as the material of the extended portions 71A to 71F.

A substantial portion of the second layer L2 except for the first coil 61 and the extended portions 71A to 71F is the first insulator layer 81. The first insulator layer 81 is made of a non-magnetic insulator such as glass, resin, and alumina. In this embodiment, the first insulator layer 81 is made of a polyimide resin same as the material of the underlying adhesive resin layer 51.

The first insulator layer 81 has a hole H2 penetrating in the third axis Z direction. The hole H2 has a quadrilateral shape when the first insulator layer 81 is seen in the third positive direction Z1. The hole H2 is located substantially at the center of the second layer L2 when the first insulator layer 81 is seen in the third negative direction Z2. An internal space of the hole H2 is connected to the internal space of the hole H1. Further, the hole H2 is located on the inner side of the first coil 61. That is, the first coil 61 surrounds the outer circumference of the hole H2.

The second magnetic part 56B is located inside the hole H2. The second magnetic part 56B fills the internal space of the hole H2. Therefore, the second magnetic part 56B is connected to the first magnetic part 56A. Material of the second magnetic part 56B is resin and magnetic material, which are the same as the material of the first magnetic part 56A.

As illustrated in FIG. 3, the third layer L3 includes six extended portions 72A to 72F, a second insulator layer 82, and a third magnetic part 56C. When the third layer L3 is seen in the third negative direction Z2, the third layer L3 has a rectangular shape same as the shape of the second layer L2. A thickness of the third layer L3 is smaller than the thickness of the second layer L2.

The extended portion 72A is located at a corner of the third layer L3 on the first positive direction X1 side and the second positive direction Y1 side. Therefore, the extended portion 72A is laminated on a surface of the extended portion 71A of the second layer L2 facing to the third positive direction Z1.

The extended portion 72B is located at a corner of the third layer L3 on the first negative direction X2 side and the second positive direction Y1 side. Therefore, the extended portion 72B is laminated on a surface of the extended portion 71B of the second layer L2 facing to the third positive direction Z1.

The extended portion 72C is located at a corner of the third layer L3 on the first negative direction X2 side and the second negative direction Y2 side. Therefore, the extended portion 72C is laminated on a surface of the extended portion 71C of the second layer L2 facing to the third positive direction Z1.

The extended portion 72D is located at a corner of the third layer L3 on the first positive direction X1 side and the second negative direction Y2 side. Therefore, the extended portion 72D is laminated on a surface of the extended portion 71D of the second layer L2 facing to the third positive direction Z1.

The extended portion 72E is located on the second positive direction Y1 side with respect to the center of the third layer L3 and at the center in the first axis X direction. That is, when the multilayer coil component 10 is seen in the third negative direction Z2, the extended portion 72E of the third layer L3 is located at the same position as the extended portion 71E of the second layer L2. Therefore, the extended portion 72E is laminated on a surface of the extended portion 71E of the second layer L2 facing to the third positive direction Z1.

The extended portion 72F is located on the second negative direction Y2 side with respect to the center of the third layer L3 and at the center in the first axis X direction. That is, when the multilayer coil component 10 is seen in the third negative direction Z2, the extended portion 72F of the third layer L3 is located at the same position as the extended portion 71F of the second layer L2. Therefore, the extended portion 72F is laminated on a surface of the extended portion 71E of the second layer L2 facing to the third positive direction Z1. The extended portions 72A to 72F are made of conductive material such as copper and silver. In this embodiment, the extended portions 72A to 72F are made of conductive material same as the material of the first coil 61.

A substantial portion of the third layer L3 except for the extended portions 72A to 72F is the second insulator layer 82. The second insulator layer 82 is made of a non-magnetic insulator such as glass, resin, and alumina. In this embodiment, the second insulator layer 82 is made of an insulator same as the material of the first insulator layer 81.

The second insulator layer 82 has a hole H3 penetrating in the third axis Z direction. The hole H3 has a quadrilateral shape when the second insulator layer 82 is seen in the third positive direction Z1. The hole H3 is located substantially at the center of the third layer L3 when the second insulator layer 82 is seen in the third negative direction Z2. An internal space of the hole H3 is connected to the internal space of the hole H2.

The third magnetic part 56C is located inside the hole H3. The third magnetic part 56C fills the internal space of the hole H3. Therefore, the third magnetic part 56C is connected to the second magnetic part 56B. Material of the third magnetic part 56C is resin and magnetic material, which are the same as the material of the first magnetic part 56A.

The fourth layer L4 includes a second coil 62, six extended portions 73A to 73F, a third insulator layer 83, and a fourth magnetic part 56D. When the fourth layer L4 is seen in the third negative direction Z2, the fourth layer L4 has a rectangular shape same as the shape of the third layer L3. A thickness of the fourth layer L4 is the same as the thickness of the second layer L2.

The extended portion 73A is located at a corner of the fourth layer L4 on the first positive direction X1 side and the second positive direction Y1 side. Therefore, the extended portion 73A is laminated on a surface of the extended portion 72A of the third layer L3 facing to the third positive direction Z1.

The extended portion 73B is located at a corner of the fourth layer L4 on the first negative direction X2 side and the second positive direction Y1 side. Therefore, the extended portion 73B is laminated on a surface of the extended portion 72B of the third layer L3 facing to the third positive direction Z1.

The extended portion 73C is located at a corner of the fourth layer L4 on the first negative direction X2 side and the second negative direction Y2 side. Therefore, the extended portion 73C is laminated on a surface of the extended portion 72C of the third layer L3 facing to the third positive direction Z1.

The extended portion 73D is located at a corner of the fourth layer L4 on the first positive direction X1 side and the second negative direction Y2 side. Therefore, the extended portion 73D is laminated on a surface of the extended portion 72D of the third layer L3 facing to the third positive direction Z1.

The extended portion 73E is located on the second positive direction Y1 side with respect to the center of the fourth layer L4 and at the center in the first axis X direction. That is, when the multilayer coil component 10 is seen in the third negative direction Z2, the extended portion 73E of the fourth layer L4 is located at the same position as the extended portion 72E of the third layer L3. Therefore, the extended portion 73E is laminated on a surface of the extended portion 72E of the third layer L3 facing to the third positive direction Z1.

The extended portion 73F is located on the second negative direction Y2 side with respect to the center of the fourth layer L4 and at the center in the first axis X direction. The extended portions 73A to 73F are made of conductive material such as copper and silver. In this embodiment, the extended portions 73A to 73F are made of conductive material same as the material of the first coil 61.

When the fourth layer L4 is seen in the third negative direction Z2, the second coil 62 extends, as a whole, in a spiral shape centering on the center of the fourth layer L4. A first end of the second coil 62 is connected to the extended portion 73D. A second end of the second coil 62 is connected to the extended portion 73F. When the fourth layer L4 is seen in the third negative direction Z2, the second coil 62 is wound clockwisely from the first end to the second end. Further, the second coil 62 is located on the third positive direction Z1 side when seen from the first coil 61. The second coil 62 is made of conductive material such as copper and silver. In this embodiment, the second coil 62 is made of conductive material same as the material of the first coil 61.

A substantial portion of the fourth layer L4 except for the second coil 62 and the extended portions 73A to 73F is the third insulator layer 83. The third insulator layer 83 is made of a non-magnetic insulator such as glass, resin, and alumina. In this embodiment, the third insulator layer 83 is made of an insulator same as the material of the first insulator layer 81.

The third insulator layer 83 has a hole H4 penetrating in the third axis Z direction. The hole H4 has a quadrilateral shape when the third insulator layer 83 is seen in the third positive direction Z1. The hole H4 is located substantially at the center of the third layer L3 when the third insulator layer 83 is seen in the third negative direction Z2. An internal space of the hole H4 is connected to the internal space of the hole H3. Further, the hole H4 is located on the inner side of the second coil 62. That is, the second coil 62 surrounds the outer circumference of the hole H4.

The fourth magnetic part 56D is located inside the hole H4. The fourth magnetic part 56D fills the internal space of the hole H4. The fourth magnetic part 56D is connected to the third magnetic part 56C. Material of the fourth magnetic part 56D is resin and magnetic material, which are the same as the material of the first magnetic part 56A.

The fifth layer L5 includes six extended portions 74A to 74F, a fourth insulator layer 84, and a fifth magnetic part 56E. When the fifth layer L5 is seen in the third negative direction Z2, the fifth layer L5 has a rectangular shape same as the shape of the fourth layer L4. A thickness of the fifth layer L5 is the same as the thickness of the third layer L3.

The extended portion 74A is located at a corner of the fifth layer L5 on the first positive direction X1 side and the second positive direction Y1 side. Therefore, the extended portion 74A is laminated on a surface of the extended portion 73A of the fourth layer L4 facing to the third positive direction Z1.

The extended portion 74B is located at a corner of the fifth layer L5 on the first negative direction X2 side and the second positive direction Y1 side. Therefore, the extended portion 74B is laminated on a surface of the extended portion 73B of the fourth layer L4 facing to the third positive direction Z1.

The extended portion 74C is located at a corner of the fifth layer L5 on the first negative direction X2 side and the second negative direction Y2 side. Therefore, the extended portion 74C is laminated on a surface of the extended portion 73C of the fourth layer L4 facing to the third positive direction Z1.

The extended portion 74D is located at a corner of the fifth layer L5 on the first positive direction X1 side and the second negative direction Y2 side. Therefore, the extended portion 74D is laminated on a surface of the extended portion 73D of the fourth layer L4 facing to the third positive direction Z1.

The extended portion 74E is located on the second positive direction Y1 side with respect to the center of the fifth layer L5 and at the center in the first axis X direction. That is, when the multilayer coil component 10 is seen in the third negative direction Z2, the extended portion 74E of the fifth layer L5 is located at the same position as the extended portion 73E of the fourth layer L4. Therefore, the extended portion 74E is laminated on a surface of the extended portion 73E of the fourth layer L4 facing to the third positive direction Z1.

The extended portion 74F is located on the second negative direction Y2 side with respect to the center of the fifth layer L5 and at the center in the first axis X direction. That is, when the multilayer coil component 10 is seen in the third negative direction Z2, the extended portion 74F of the fifth layer L5 is located at the same position as the extended portion 73F of the fourth layer L4. Therefore, the extended portion 74F is laminated on a surface of the extended portion 74F of the fourth layer L4 facing to the third positive direction Z1. The extended portions 74A to 74F are made of conductive material such as copper and silver. In this embodiment, the extended portions 74A to 74F are made of conductive material same as the material of the first coil 61.

A substantial portion of the fifth layer L5 except for the extended portions 74A to 74F is the fourth insulator layer 84. The fourth insulator layer 84 is made of a non-magnetic insulator such as glass, resin, and alumina. In this embodiment, the fourth insulator layer 84 is made of an insulator same as the material of the first insulator layer 81.

The fourth insulator layer 84 has a hole H5 penetrating in the third axis Z direction. The hole H5 has a quadrilateral shape when the fourth insulator layer 84 is seen in the third positive direction Z1. The hole H5 is located substantially at the center of the fifth layer L5 when the fourth insulator layer 84 is seen in the third negative direction Z2. An internal space of the hole H5 is connected to the internal space of the hole H4.

The fifth magnetic part 56E is located inside the hole H5. The fifth magnetic part 56E fills the internal space of the hole H5. The fifth magnetic part 56E is connected to the fourth magnetic part 56D. Material of the fifth magnetic part 56E is resin and magnetic material, which are the same as the material of the first magnetic part 56A.

The sixth layer L6 includes a third coil 63, six extended portions 75A to 75F, a fifth insulator layer 85, and a sixth magnetic part 56F. When the sixth layer L6 is seen in the third negative direction Z2, the sixth layer L6 has a rectangular shape same as the shape of the fifth layer L5. A thickness of the sixth layer L6 is smaller than that of the second layer L2. Specifically, the thickness of the sixth layer L6 is, for example, 7 µm or larger and smaller than 9 µm.

The extended portion 75A is located at a corner of the sixth layer L6 on the first positive direction X1 side and the second positive direction Y1 side. Therefore, the extended portion 75A is laminated on a surface of the extended portion 74A of the fifth layer L5 facing to the third positive direction Z1.

The extended portion 75B is located at a corner of the sixth layer L6 on the first negative direction X2 side and the second positive direction Y1 side. Therefore, the extended portion 75B is laminated on a surface of the extended portion 74B of the fifth layer L5 facing to the third positive direction Z1.

The extended portion 75C is located at a corner of the sixth layer L6 on the first negative direction X2 side and the second negative direction Y2 side. Therefore, the extended portion 75C is laminated on a surface of the extended portion 74C of the fifth layer L5 facing to the third positive direction Z1.

The extended portion 75D is located at a corner of the sixth layer L6 on the first positive direction X1 side and the second negative direction Y2 side. Therefore, the extended portion 75D is laminated on a surface of the extended portion 74D of the fifth layer L5 facing to the third positive direction Z1.

The extended portion 75E is located on the second positive direction Y1 side with respect to the center of the sixth layer L6 and at the center in the first axis X direction. That is, when the multilayer coil component 10 is seen in the third negative direction Z2, the extended portion 75E of the sixth layer L6 is located at the same position as the extended portion 74E of the fifth layer L5. Therefore, the extended portion 75E is laminated on a surface of the extended portion 74E of the fifth layer L5 facing to the third positive direction Z1.

The extended portion 75F is located on the second negative direction Y2 side with respect to the center of the sixth layer L6 and at the center in the first axis X direction. That is, when the multilayer coil component 10 is seen in the third negative direction Z2, the extended portion 75F of the sixth layer L6 is located at the same position as the extended portion 74F of the fifth layer L5. Therefore, the extended portion 75F is laminated on a surface of the extended portion 75F of the fifth layer L5 facing to the third positive direction Z1. The extended portions 75A to 75F are made of conductive material such as copper and silver. In this embodiment, the extended portions 74A to 75F are made of conductive material same as the material of the first coil 61.

When the sixth layer L6 is seen in the third negative direction Z2, the third coil 63 extends, as a whole, in a spiral shape centering on the center of the sixth layer L6. A first end of the third coil 63 is connected to the extended portion 75E. A second end of the third coil 63 is connected to the extended portion 75B. When the sixth layer L6 is seen in the third negative direction Z2, the third coil 63 is wound clockwisely from the first end to the second end. The third coil 63 is made of conductive material such as copper and silver. In this embodiment, the third coil 63 is made of conductive material same as the material of the first coil 61.

A substantial portion of the sixth layer L6 except for the third coil 63 and the extended portions 75A to 75F is the fifth insulator layer 85. The fifth insulator layer 85 is made of a non-magnetic insulator such as glass, resin, and alumina. In this embodiment, the fifth insulator layer 85 is made of an insulator same as the material of the first insulator layer 81.

The fifth insulator layer 85 has a hole H6 penetrating in the third axis Z direction. The hole H6 has a quadrilateral shape when the fifth insulator layer 85 is seen in the third positive direction Z1. The hole H6 is located substantially at the center of the sixth layer L6 when the fifth insulator layer 85 is seen in the third negative direction Z2. An internal space of the hole H6 is connected to the internal space of the hole H5. Further, the hole H6 is located on the inner side of the third coil 63. That is, the third coil 63 surrounds the outer circumference of the hole H6.

The sixth magnetic part 56F is located inside the hole H6. The sixth magnetic part 56F fills the internal space of the hole H6. The sixth magnetic part 56F is connected to the fifth magnetic part 56E. Material of the sixth magnetic part 56F is resin and magnetic material, which are the same as the material of the first magnetic part 56A.

The seventh layer L7 includes six extended portions 76A to 76F, a sixth insulator layer 86, and a seventh magnetic part 56G. When the seventh layer L7 is seen in the third negative direction Z2, the seventh layer L7 has a rectangular shape same as the shape of the sixth layer L6. A thickness of the seventh layer L7 is the same as the thickness of the third layer L3.

The extended portion 76A is located at a corner of the seventh layer L7 on the first positive direction X1 side and the second positive direction Y1 side. Therefore, the extended portion 76A is laminated on a surface of the extended portion 75A of the sixth layer L6 facing to the third positive direction Z1.

The extended portion 76B is located at a corner of the seventh layer L7 on the first negative direction X2 side and the second positive direction Y1 side. Therefore, the extended portion 76B is laminated on a surface of the extended portion 75B of the sixth layer L6 facing to the third positive direction Z1.

The extended portion 76C is located at a corner of the seventh layer L7 on the first negative direction X2 side and the second negative direction Y2 side. Therefore, the extended portion 76C is laminated on a surface of the extended portion 75C of the sixth layer L6 facing to the third positive direction Z1.

The extended portion 76D is located at a corner of the seventh layer L7 on the first positive direction X1 side and the second negative direction Y2 side. Therefore, the extended portion 76D is laminated on a surface of the extended portion 75D of the sixth layer L6 facing to the third positive direction Z1.

The extended portion 76E is located on the second positive direction Y1 side with respect to the center of the seventh layer L7 and at the center in the first axis X direction. That is, when the multilayer coil component 10 is seen in the third negative direction Z2, the extended portion 76E of the seventh layer L7 is located at the same position as the extended portion 75E of the sixth layer L6. Therefore, the extended portion 76E is laminated on a surface of the extended portion 75E of the sixth layer L6 facing to the third positive direction Z1.

The extended portion 76F is located on the second negative direction Y2 side with respect to the center of the seventh layer L7 and at the center in the first axis X direction. That is, when the multilayer coil component 10 is seen in the third negative direction Z2, the extended portion 76F of the seventh layer L7 is located at the same position as the extended portion 75F of the sixth layer L6. Therefore, the extended portion 76F is laminated on a surface of the extended portion 75F of the sixth layer L6 facing to the third positive direction Z1. The extended portions 76A to 76F are made of conductive material such as copper and silver. In this embodiment, the extended portions 76A to 76F are made of conductive material same as the material of the first coil 61.

A substantial portion of the seventh layer L7 except for the extended portions 76A to 76F is the sixth insulator layer 86. The sixth insulator layer 86 is made of a non-magnetic insulator such as glass, resin, and alumina. In this embodiment, the sixth insulator layer 86 is made of an insulator same as the material of the first insulator layer 81.

The sixth insulator layer 86 has a hole H7 penetrating in the third axis Z direction. The hole H7 has a quadrilateral shape when the sixth insulator layer 86 is seen in the third positive direction Z1. The hole H7 is located substantially at the center of the seventh layer L7 when the sixth insulator layer 86 is seen in the third negative direction Z2. An internal space of the hole H7 is connected to the internal space of the hole H6.

The seventh magnetic part 56G is located inside the hole H7. The seventh magnetic part 56G fills the internal space of the hole H7. The seventh magnetic part 56G is connected to the sixth magnetic part 56F. Material of the seventh magnetic part 56G is resin and magnetic material, which are the same as the material of the first magnetic part 56A.

The eighth layer L8 includes a fourth coil 64, six extended portions 77A to 77F, a seventh insulator layer 87, and an eighth magnetic part 56H. When the eighth layer L8 is seen in the third negative direction Z2, the eighth layer L8 has a rectangular shape same as the shape of the seventh layer L7. A thickness of the eighth layer L8 is the same as the thickness of the sixth layer L6.

The extended portion 77A is located at a corner of the eighth layer L8 on the first positive direction X1 side and the second positive direction Y1 side. Therefore, the extended portion 77A is laminated on a surface of the extended portion 76A of the seventh layer L7 facing to the third positive direction Z1.

The extended portion 77B is located at a corner of the eighth layer L8 on the first negative direction X2 side and the second positive direction Y1 side. Therefore, the extended portion 77B is laminated on a surface of the extended portion 75B of the seventh layer L7 facing to the third positive direction Z1.

The extended portion 77C is located at a corner of the eighth layer L8 on the first negative direction X2 side and the second negative direction Y2 side. Therefore, the extended portion 77C is laminated on a surface of the extended portion 76C of the seventh layer L7 facing to the third positive direction Z1.

The extended portion 77D is located at a corner of the eighth layer L8 on the first positive direction X1 side and the second negative direction Y2 side. Therefore, the extended portion 77D is laminated on a surface of the extended portion 76D of the seventh layer L7 facing to the third positive direction Z1.

The extended portion 77E is located on the second positive direction Y1 side with respect to the center of the eighth layer L8 and at the center in the first axis X direction. That is, when the multilayer coil component 10 is seen in the third negative direction Z2, the extended portion 77E of the eighth layer L8 is located at the same position as the extended portion 76E of the seventh layer L7. Therefore, the extended portion 77E is laminated on a surface of the extended portion 76E of the seventh layer L7 facing to the third positive direction Z1.

The extended portion 77F is located on the second negative direction Y2 side with respect to the center of the eighth layer L8 and at the center in the first axis X direction. That is, when the multilayer coil component 10 is seen in the third negative direction Z2, the extended portion 77F of the eighth layer L8 is located at the same position as the extended portion 76F of the seventh layer L7. Therefore, the extended portion 77F is laminated on a surface of the extended portion 76F of the seventh layer L7 facing to the third positive direction Z1. The extended portions 77A to 77F are made of conductive material such as copper and silver. In this embodiment, the extended portions 77A to 77F are made of conductive material same as the material of the first coil 61.

When the eighth layer L8 is seen in the third negative direction Z2, the fourth coil 64 extends, as a whole, in a spiral shape centering on the center of the eighth layer L8. A first end of the fourth coil 64 is connected to the extended portion 77F. A second end of the fourth coil 64 is connected to the extended portion 77C. When the eighth layer L8 is seen in the third negative direction Z2, the fourth coil 64 is wound clockwisely from the first end to the second end. Further, the fourth coil 64 is located on the third positive direction Z1 side when seen from the third coil 63. The fourth coil 64 is made of conductive material such as copper and silver. In this embodiment, the fourth coil 64 is made of conductive material same as the material of the first coil 61.

A substantial portion of the eighth layer L8 except for the fourth coil 64 and the extended portions 77A to 77F is the seventh insulator layer 87. The seventh insulator layer 87 is made of a non-magnetic insulator such as glass, resin, and alumina. In this embodiment, the seventh insulator layer 87 is made of an insulator same as the material of the first insulator layer 81.

The seventh insulator layer 87 has a hole H8 penetrating in the third axis Z direction. The hole H8 has a quadrilateral shape when the seventh insulator layer 87 is seen in the third positive direction Z1. The hole H8 is located substantially at the center of the eighth layer L8 when the seventh insulator layer 87 is seen in the third negative direction Z2. An internal space of the hole H8 is connected to the internal space of the hole H7. Further, the hole H8 is located on the inner side of the fourth coil 64. That is, the fourth coil 64 surrounds the outer circumference of the hole H8.

The eighth magnetic part 56H is located inside the hole H8. The eighth magnetic part 56H fills the internal space of the hole H8. The eighth magnetic part 56H is connected to the seventh magnetic part 56G. Material of the eighth magnetic part 56H is resin and magnetic material, which are the same as the material of the first magnetic part 56A.

The ninth layer L9 includes an eighth insulator layer 88 and a ninth magnetic part 56I. When the ninth layer L9 is seen in the third negative direction Z2, the ninth layer L9 has a rectangular shape same as the shape of the eighth layer L8. A thickness of the ninth layer L9 is the same as the thickness of the third layer L3.

The eighth insulator layer 88 is made of a non-magnetic insulator such as glass, resin, and alumina. In this embodiment, the eighth insulator layer 88 is made of an insulator same as the material of the first insulator layer 81.

The eighth insulator layer 88 has a hole H9 penetrating in the third axis Z direction. The hole H9 has a quadrilateral shape when the eighth insulator layer 88 is seen in the third positive direction Z1. The hole H9 is located substantially at the center of the ninth layer L9 when the eighth insulator layer 88 is seen in the third negative direction Z2. An internal space of the hole H9 is connected to the internal space of the hole H8.

The ninth magnetic part 56I is located inside the hole H9. The ninth magnetic part 56I fills the internal space of the hole H9. The ninth magnetic part 56I is connected to the eighth magnetic part 56H. Material of the ninth magnetic part 56I is resin and magnetic material, which are the same as the material of the first magnetic part 56A.

The tenth layer L10 includes a first adhesive part 52A and a tenth magnetic part 56J. When the tenth layer L10 is seen in the third negative direction Z2, the tenth layer L10 has a rectangular shape same as the shape of the ninth layer L9.

The first adhesive part 52A is made of an organic adhesive such as a polyimide resin. In this embodiment, the first adhesive part 52A is made of material same as the material of the underlying adhesive resin layer 51.

The first adhesive part 52A has a hole H10 penetrating in the third axis Z direction. Note that the shape and the size of the hole H10 will be described later. An internal space of the hole H10 is connected to the internal space of the hole H9.

The tenth magnetic part 56J is located inside the hole H10. The tenth magnetic part 56J fills the internal space of the hole H10. The tenth magnetic part 56J is connected to the ninth magnetic part 56I. Material of the tenth magnetic part 56J is resin and magnetic material, which are the same as the material of the first magnetic part 56A.

The eleventh layer L11 is constituted of a second adhesive part 52B. When the eleventh layer L11 is seen in the third negative direction Z2, the eleventh layer L11 has a rectangular shape same as the shape of the tenth layer L10. The second adhesive part 52B is made of an organic adhesive such as a polyimide resin. The second adhesive part 52B is integrated with the first adhesive part 52A.

By the second to ninth layers L2 to L9 as described above being laminated, the multilayer body 30 constituted of the first to eighth insulator layers 81 to 88 is configured. Further, the first adhesive part 52A of the tenth layer L10 and the second adhesive part 52B of the eleventh layer L11 constitute the overlying adhesive resin layer 52. Moreover, the first to tenth magnetic parts 56A to 56J constitute the magnetic resin 56.

Moreover, the first to fourth coils 61 to 64 extend inside the multilayer body 30. The first coil 61 and the third coil 63 are electrically connected to each other by the extended portions 71E to 75E. The first coil 61 and the third coil 63 each in a spiral shape are arranged in this order in the third positive direction Z1, and thus, the first coil 61 and the third coil 63 extend in a helical shape as a whole. Further, the first coil 61 and the third coil 63 are exposed to the outside of the multilayer body 30 and the underlying adhesive resin layer 51 by the extended portion 71A and the extended portions 71B to 75B.

Moreover, the second coil 62 and the fourth coil 64 are electrically connected to each other by the extended portions 73F to 77F. The second coil 62 and the fourth coil 64 each in a spiral shape are arranged in this order in the third positive direction Z1, and thus, the second coil 62 and the fourth coil 64 extend in a helical shape as a whole. Further, the second coil 62 and the fourth coil 64 are exposed to the outside of the multilayer body 30 and the underlying adhesive resin layer 51 by the extended portions 71D to 73D and the extended portions 71C to 77C. Therefore, together with the first coil 61 and the third coil 63, the second coil 62 and the fourth coil 64 constitute a common mode choke coil.

The upper magnetic substrate 40 has a rectangular parallelepiped shape. The upper magnetic substrate 40 is made of magnetic material. The magnetic material is, for example, a sintered body of ferrite ceramics. In this embodiment, the upper magnetic substrate 40 is made of magnetic material same as the lower magnetic substrate 20. The upper magnetic substrate 40 is laminated on an upper surface 30A of the overlying adhesive resin layer 52 facing to the third positive direction Z1. Therefore, the upper magnetic substrate 40 is adhered to the upper surface 30A of the multilayer body 30 with the overlying adhesive resin layer 52 interposed therebetween.

As illustrated in FIGS. 2 and 3, the multilayer coil component 10 includes four connectors 91A to 91D and four outer electrodes 92A to 92D.

The connector 91A is located on an inner surface of the notch 21A. The connector 91A exists over the entire inner surface of the notch 21A. The connector 91B is located on an inner surface of the notch 21B. The connector 91B exists over the entire inner surface of the notch 21B. The connector 91C is located on an inner surface of the notch 21C. The connector 91C exists over the entire inner surface of the notch 21C. The connector 91D is located on an inner surface of the notch 21D. The connector 91D exists over the entire inner surface of the notch 21D. These connectors 91A to 91D are made of conductive material whose main component is copper.

The connector 91A exists over the entire inner surface of the notch 21A, and thus, the extended portion 71A exposing to the outside of the multilayer body 30 and the underlying adhesive resin layer 51 is connected to the connector 91A. Similarly, the connector 91B exists over the entire inner surface of the notch 21B, and thus, the extended portion 71B exposing to the outside of the multilayer body 30 and the underlying adhesive resin layer 51 is connected to the connector 91B. The connector 91C exists over the entire inner surface of the notch 21C, and thus, the extended portion 71C exposing to the outside of the multilayer body 30 and the underlying adhesive resin layer 51 is connected to the connector 91C. The connector 91D exists over the entire inner surface of the notch 21D, and thus, the extended portion 71D exposing to the outside of the multilayer body 30 and the underlying adhesive resin layer 51 is connected to the connector 91D.

The outer electrode 92A exists on the second principal surface MF2 and is connected to the connector 91A. The outer electrode 92B exists on the second principal surface MF2 and is connected to the connector 91B. The outer electrode 92C exists on the second principal surface MF2 and is connected to the connector 91C. The outer electrode 92D exists on the second principal surface MF2 and is connected to the connector 91D. The outer electrodes 92A to 92D are not connected to each other.

In this manner, the outer electrode 92A is connected to the first coil 61 through the connector 91A and the extended portion 71A. The outer electrode 92B is connected to the first coil 61 through the connector 91B and the extended portion 71B. The outer electrode 92C is connected to the second coil 62 through the connector 91C and the extended portion 71C. The outer electrode 92D is connected to the second coil 62 through the connector 91D and the extended portion 71D.

The outer electrodes 92A to 92D are made of conductive material whose main component is copper. In this embodiment, the outer electrodes 92A to 92D are made of conductive material same as the material of the connectors 91A to 91D.

A dimension of the multilayer coil component 10 configured as described above in the first axis X direction is 0.35 mm or smaller. Further, a dimension of the multilayer coil component 10 in the second axis Y direction is 0.50 mm or smaller.

### Through-Hole and Accommodation Space

As illustrated in FIG. 5, the multilayer body 30 has a through-hole TH. The through-hole TH penetrates the multilayer body 30 in the third axis Z direction. The through-hole TH is constituted of the holes H2 to H9 described above. The through-hole TH has a truncated quadrangular pyramid shape having a cross-sectional area reducing in the third negative direction Z2. That is, although the holes H2 to H9 each has a quadrilateral shape in plan view, their opening areas gradually decrease from the hole H9 to the hole H2.

The first to fourth coils 61 to 64 respectively surround the outer circumferences of the holes H2 to H8 existing in the corresponding layers. Therefore, the first to fourth coils 61 to 64 extend, as a whole, in a helical shape so as to surround an outer circumference of the through-hole TH.

The overlying adhesive resin layer 52 has an accommodation space CS. The accommodation space CS is the internal space of the hole H10 described above. The accommodation space CS is connected to the internal space of the hole H9. That is, the accommodation space CS is connected to the through-hole TH.

When the multilayer coil component 10 is seen in the third positive direction Z1, an outer edge of the accommodation space CS is located on an outer side of an outer edge of the through-hole TH. That is, the hole H10 of the tenth layer L10 has a quadrilateral shape with a larger area than the area of the hole H9 of the ninth layer L9. Further, an opening edge of the hole H10 is entirely separated from an opening edge of the hole H9. As a result, the accommodation space CS spreads in a direction perpendicular to the third axis Z beyond the opening edge of the through-hole TH. Note that the expression of “when the multilayer coil component 10 is seen” as used herein does not indicate to visually recognize the multilayer coil component 10 actually, but indicate to see, transparently through the multilayer coil component 10, the outer edge of the accommodation space CS and the outer edge of the through-hole TH.

Further, when the multilayer coil component 10 is seen in the third positive direction Z1, a portion of the accommodation space CS overlaps the first to fourth coils 61 to 64. Specifically, assume that a range of the first coil 61 from an inner end thereof to a portion thereof wound 360 degrees from the inner end is an innermost turn. Note that the inner end of the first coil 61 is a portion of the first coil 61 connected to the extended portion 71E. When the multilayer coil component 10 is seen in the third positive direction Z1, the accommodation space CS overlaps only the innermost turn. That is, when the multilayer coil component 10 is seen in the third positive direction Z1, the accommodation space CS does not spread to a portion of the first coil 61 wound more than 360 degrees from the inner end.

As described above, the entire eleventh layer L11 is the second adhesive part 52B. The second adhesive part 52B does not have a hole. Therefore, the accommodation space CS opens on the through-hole TH side whereas it does not open on the upper magnetic substrate 40 side. Thus, the overlying adhesive resin layer 52 exists between the accommodation space CS and the upper magnetic substrate 40. Note that “the accommodation space CS opens” means that at least it is not closed by the overlying adhesive resin layer 52. That is, even if the entire opening of the accommodation space CS is occupied by another member, the accommodation space CS can be said to open when the accommodation space CS has an opening considering the overlying adhesive resin layer 52 alone.

Further, the magnetic resin 56 fills the through-hole TH and the accommodation space CS. That is, the magnetic resin 56 is filled into the through-hole TH and the accommodation space CS. Note that, in the multilayer coil component 10, it is unnecessary that the accommodation space CS is space such as a gap, an unfilled space, or a vacuum. Therefore, the accommodation space CS may be filled up with another member. Specifically, the accommodation space CS includes the case like this embodiment where the accommodation space CS is entirely filled up with the magnetic resin 56 and does not exist as an unfilled space or a vacuum. Further, the magnetic resin 56 also fills the internal space of the hole H1 in addition to the through-hole TH and the accommodation space CS. Therefore, the magnetic resin 56 is in contact with the lower magnetic substrate 20. Note that, in FIGS. 3 and 5, the magnetic resin 56 is illustrated to fill the entire accommodation space CS. However, an unfilled space may be remained in a portion of the accommodation space CS as the magnetic resin 56 does not spread to the portion of the accommodation space CS.

Further, an opening area of the upper surface 30A of the through-hole TH is 8% or above and 11% or below (i.e., from 8% to 11%) with respect to an area obtained by adding an area of the upper surface 30A and the opening area of the through-hole TH. That is, when the multilayer coil component 10 is seen in the third negative direction Z2, the opening area of the through-hole TH is 8% or above and 11% or below (i.e., from 8% to 11%) of an area in a contour of the multilayer body 30 on the upper surface 30A.

### Method of Forming Magnetic Resin

In a manufacturing method of the multilayer coil component 10 described above, a process of forming the magnetic resin 56 is described.

First, the multilayer body 30 without the through-hole TH is prepared. Specifically, an insulation resin and a conductive resin are laminated on the first principal surface MF1 of the lower magnetic substrate 20 to obtain a desired circuit pattern through photolithography. Thus, the underlying adhesive resin layer 51 without the hole H1 and the multilayer body 30 without the through-hole TH are prepared.

Next, the first adhesive part 52A is formed on the surface of the multilayer body 30 facing to the third positive direction Z1. For example, the hole H10 is opened in the range of the accommodation space CS through photolithography, for example.

Next, the through-hole TH is opened in the multilayer body 30. For example, the through-hole TH is formed in a method of laser irradiation, shot blasting, or the like. At this time, the hole H1 is opened in the underlying adhesive resin layer 51. Note that when the through-hole TH is formed through laser irradiation, shot blasting, or the like, it is difficult to form an inner circumferential surface of the through-hole TH to be parallel to the third axis Z. Therefore, the opening of the through-hole TH becomes smaller toward the third negative direction Z2.

Then, the through-hole TH is filled up with the magnetic resin 56. First, the magnetic resin 56 is filled into the through-hole TH so as to overflow therefrom to the accommodation space CS. Next, the second adhesive part 52B is formed on the surface of the upper magnetic substrate 40 facing to the third negative direction Z2. Next, the multilayer body 30 and the upper magnetic substrate 40 are laminated so that the first adhesive part 52A and the second adhesive part 52B are stacked together. Therefore, the magnetic resin 56 is sandwiched in an amount larger than the amount to fill up the through-hole TH, and thus, the magnetic resin 56 can easily be filled inside the through-hole TH. Thereby, an unfilled space is unlikely to be formed inside the through-hole TH. Further, the magnetic resin 56 which is overflowed from the through-hole TH is accommodated in the accommodation space CS.

### Effects of Embodiment

The embodiment described above achieves the following effects.

(1) According to the embodiment described above, the overlying adhesive resin layer 52 includes the accommodation space CS. In the manufacturing process of the multilayer coil component 10, the accommodation space CS of the overlying adhesive resin layer 52 can function as a space to which the filled magnetic resin 56 escapes. That is, the filling amount of magnetic resin 56 can be set to, at the maximum, an amount obtained by adding a volume of the through-hole TH and a volume of the accommodation space CS. Therefore, even when variations in the filling amount of magnetic resin 56 occur due to an error or the like in the manufacturing, the filling amount of magnetic resin 56 is unlikely to fall below the volume of the through-hole TH. As a result, a possibility that the magnetic resin 56 spreads over the entire through-hole TH becomes higher.

Note that the magnetic resin 56 which is overflowed from the through-hole TH while being filled is accommodated in the accommodation space CS. Therefore, the overflowed magnetic resin 56 exists within a range of the overlying adhesive resin layer 52 in the third axis Z direction. In this position, even if the magnetic resin 56 exists, a possibility of adversely affecting, for example, characteristics of the multilayer coil component 10 is low.

(2) According to the embodiment described above, when the multilayer coil component 10 is seen in the third positive direction Z1, a portion of the accommodation space CS overlaps the first to fourth coils 61 to 64. That is, the accommodation space CS spreads to the portion overlapping the first to fourth coils 61 to 64 where the through-hole TH does not exist. Therefore, a suitable volume can be secured as the volume of the accommodation space CS. Thus, when the magnetic resin 56 is filled, the filling amount of magnetic resin 56 can be set to an amount suitably larger than the volume of the through-hole TH. As a result, the possibility that the magnetic resin 56 spreads over the entire through-hole TH becomes further higher.

(3) According to the embodiment described above, when the multilayer coil component 10 is seen in the third positive direction Z1, the accommodation space CS overlaps only the innermost turn. Therefore, the accommodation space CS does not spread excessively. In other words, the area of the first adhesive part 52A of the overlying adhesive resin layer 52 does not become excessively small. Thus, it can be secured that the multilayer body 30 and the upper magnetic substrate 40 are sufficiently adhered together by the overlying adhesive resin layer 52.

(4) According to the embodiment described above, the accommodation space CS opens on the through-hole TH side and does not open on the upper magnetic substrate 40 side. Therefore, the overlying adhesive resin layer 52 exists also between the magnetic resin 56 filled into the accommodation space CS and the upper magnetic substrate 40. Therefore, the multilayer body 30 can firmly be adhered by the upper magnetic substrate 40, and it can be prevented that the existence of the through-hole TH lowers adhesive to the multilayer body 30.

(5) According to the embodiment described above, the magnetic resin 56 is in contact with the lower magnetic substrate 20. Therefore, the magnetic resin 56 is filled up to the opening of the through-hole TH on the third negative direction Z2 side. Thus, a density of a magnetic flux from the magnetic resin 56 to the lower magnetic substrate 20 can be improved. As a result, an inductance value obtained from the multilayer coil component 10 further improves.

(6) According to the embodiment described above, the opening area of the through-hole TH at the upper surface 30A is 8% or above and 11% or below 9i.e., from 8% to 11%) with respect to an area obtained by adding an area of the upper surface 30A and the opening area. Therefore, it can be suppressed that the magnetic resin 56 filled into the through-hole TH becomes excessively large. Thus, the range where the first to fourth coils 61 to 64 extend can sufficiently be secured. Further, as a result of securing the opening area of the through-hole TH to be 8% or above, the magnetic resin 56 in an amount sufficient to improve the inductance value exists. Improvement in the inductance value obtained from the multilayer coil component 10 compared to a case without the magnetic resin 56 is significant.

### Other Embodiments

The embodiment described above can be embodied while being changed as follows. The embodiment described above and the following modifications can be embodied while being combined within a range without technical contradiction.

The size of the multilayer coil component 10 is not limited to the example of the embodiment described above. The dimension of the multilayer coil component 10 in the first axis X direction may be larger than 0.35 mm. The dimension of the multilayer coil component 10 in the second axis Y direction may be larger than 0.50 mm.

When the lower magnetic substrate 20 is seen in the third positive direction Z1, the lower magnetic substrate 20 may have a square shape. That is, the maximum dimension of the lower magnetic substrate 20 in the first axis X direction may be equal to the maximum dimension of the lower magnetic substrate 20 in the second axis Y direction. Further, corresponding to the shape of the lower magnetic substrate 20, the shapes of the multilayer body 30 and the upper magnetic substrate 40 may also be changed.

The configuration of the multilayer body 30 may suitably be changed. For example, the way of each coil being extended, the number of coils, the position of each extended portion, the shape of each extended portion, or the like may suitably be changed corresponding to the characteristics desired as the multilayer coil component 10. As long as the multilayer body 30 includes a plurality of insulator layers and a through-hole TH penetrating the plurality of insulator layers, the technique related to the accommodation space CS described above can be applied. Further, the thickness of each layer may be identical to or different from each other.

The lower magnetic substrate 20 may be omitted, or may be a resin containing magnetic powder without being a sintered body. The upper magnetic substrate 40 may be a resin containing magnetic powder without being a sintered body.

The underlying adhesive resin layer 51 may be omitted. In this case, the lower magnetic substrate 20 and the multilayer body 30 may be connected together by pressure bounding or the like. Note that when the underlying adhesive resin layer 51 is omitted, the magnetic resin 56 is in contact with the lower magnetic substrate 20.

It is not always necessary that the underlying adhesive resin layer 51 has the hole H1. In this case, the magnetic resin 56 does not come in contact with the lower magnetic substrate 20.

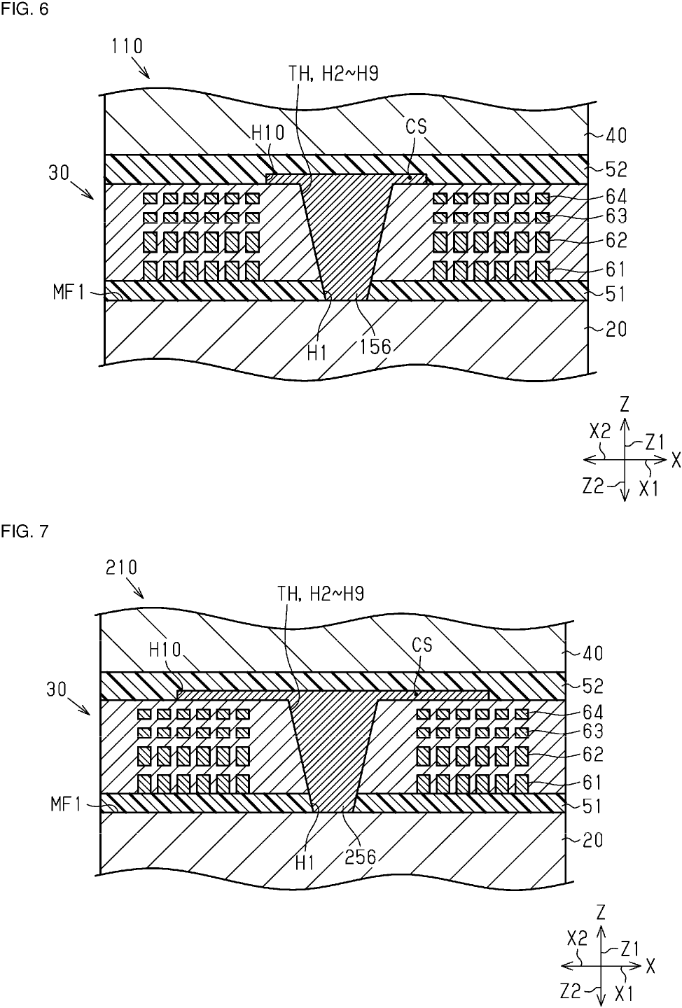

When a multilayer coil component 110 is seen in the third positive direction Z1, the size of the accommodation space CS may suitably be changed as long as the outer edge of the accommodation space CS is located on the outer side of the outer edge of the through-hole TH. For example, in the multilayer coil component 110 of a modification illustrated in FIG. 6, when the multilayer coil component 110 is seen in the third positive direction Z1, the accommodation space CS does not overlap any of the first to fourth coils 61 to 64. As described above, it is not always necessary that, for example, the accommodation space CS spreads to the first to fourth coils 61 to 64 when the multilayer coil component 110 is seen in the third positive direction Z1, as long as a magnetic resin 156 in an amount larger than the amount filling up the through-hole TH can be accommodated.

Further, for example, in a multilayer coil component 210 of a modification illustrated in FIG. 7, when the multilayer coil component 110 is seen in the third positive direction Z1, a portion of the accommodation space CS overlaps a portion of the first coil 61 from its inner end to a portion wound 1080 degrees from the inner end. In other words, the accommodation space CS overlaps a range of the first coil 61 from the inner end thereof to a substantially midpoint thereof in length. Therefore, a space into which a larger amount of magnetic resin 256 leaks can easily be secured. Further, not being limited to the modification illustrated in FIG. 7, when the multilayer coil component 110 is seen in the third positive direction Z1, a portion of the accommodation space CS may overlap the half or more of the wound range of the first coil 61 or overlap the entire first coil 61. As described above, the overlapping range of the accommodation space CS and the first coil 61 is not limited to the example of the embodiment described above.

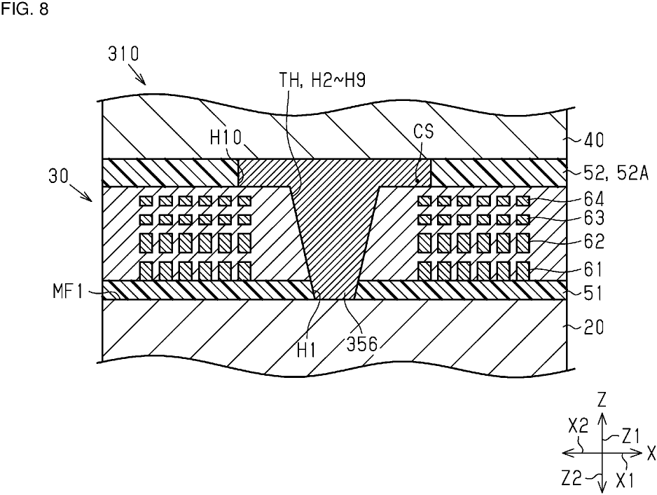

The second adhesive part 52B may be omitted. In this case, like a multilayer coil component 310 of a modification illustrated in FIG. 8, the overlying adhesive resin layer 52 is constituted only of the first adhesive part 52A. Since the hole H10 penetrates the first adhesive part 52A, which is the overlying adhesive resin layer 52, the hole H10 opens on both the through-hole TH side and the upper magnetic substrate 40 side. In this manner, when the accommodation space CS penetrates the overlying adhesive resin layer 52 in the third axis Z direction, a magnetic resin 356 can be in contact with the upper magnetic substrate 40. Therefore, the magnetic resin 356 penetrates the multilayer body 30 and the overlying adhesive resin layer 52 to reach the upper magnetic substrate 40. Thus, when current is applied to the first to fourth coils 61 to 64, a density of a magnetic flux from the magnetic resin 356 to the upper magnetic substrate 40 can be improved. As a result, an inductance value obtained from the multilayer coil component 10 can improve.

The shape of the through-hole TH is not limited to the example of the embodiment described above. For example, the through-hole TH may have a circular pillar shape, a polygonal pillar shape, or another pillar shape.

The opening area of the through-hole TH at the upper surface 30A may be below 8% or above 11% with respect to an area obtained by adding an area of the upper surface 30A and the opening area of the multilayer body 30.

The configuration of the first to fourth coils 61 to 64 may suitably be changed. For example, the second to fourth coils 62 to 64 may be omitted. In this case, the first coil 61 may extend to surround the outer circumference of the through-hole TH. Note that, in order to surround the outer circumference of the through-hole TH, it is necessary that the coil is wound 360 degrees or more over the same or different layer(s).

The method of forming the magnetic resin 56 is not limited to the forming method in the embodiment described above. For example, the magnetic resin 56 may be formed as follows. First, the through-hole TH is formed in the multilayer body 30 in a method of laser irradiation and shot blasting. Then, the through-hole TH is filled up with the magnetic resin 56 in an amount equal to or larger than the volume of the through-hole TH so that the magnetic resin 56 overflows from the through-hole TH. Therefore, the magnetic resin 56 is caused to spread on the surface of the multilayer body 30 facing to the third positive direction Z1, over an area equal to or larger than the opening area of the through-hole TH. Then, an adhesive resin may be applied only on the surface of the multilayer body 30 facing to the third positive direction Z1. In this case, if the adhesive resin is not applied to the magnetic resin 56, the second adhesive part 52B can be omitted. Further, if the adhesive resin is applied on the surface of the magnetic resin 56 facing to the third positive direction Z1, the second adhesive part 52B can be formed. Moreover, in this method, since processing to the overlying adhesive resin layer 52 is unnecessary, a photosensitive function such as the insulator layer used in the multilayer body 30 is unnecessary. Therefore, a resin without a photosensitive function can be used.

Although the laminating direction is the third positive direction Z1 in the embodiment described above, the laminating direction may be the third negative direction Z2.

What is claimed is:

1. A multilayer coil component comprising:
a multilayer body including
a plurality of insulator layers laminated in a laminating direction, and
a through-hole penetrating the plurality of insulator layers in the laminating direction;
a coil extending inside the multilayer body to surround an outer circumference of the through-hole;
a magnetic resin including resin and magnetic material and filled into the through-hole;
an adhesive resin layer laminated on a surface facing to the laminating direction of an outer surface of the multilayer body; and
a magnetic substrate adhered to the multilayer body with the adhesive resin layer interposed therebetween, wherein
the adhesive resin layer includes an accommodation space connected to the through-hole,
an outer edge of the accommodation space is further outside an outer edge of the through-hole when viewed in the laminating direction, and
a portion of the magnetic resin is inside the accommodation space.

2. The multilayer coil component according to claim 1, wherein
a portion of the accommodation space overlaps the coil when viewed in the laminating direction.

3. The multilayer coil component according to claim 2, wherein
when a range of the coil from an inner end thereof to a portion wound 360 degrees from the inner end is an innermost turn, the accommodation space overlaps only the innermost turn when viewed in the laminating direction.

4. The multilayer coil component according to claim 1, wherein
the accommodation space opens on a through-hole side and does not open on a magnetic substrate side.

5. The multilayer coil component according to claim 1, wherein
the accommodation space penetrates the adhesive resin layer in the laminating direction.

6. The multilayer coil component according to claim 1, wherein
the magnetic substrate is an upper magnetic substrate, and
the multilayer coil component further comprises a lower magnetic substrate which is on an opposite side from the laminating direction with respect to the multilayer body,
wherein the magnetic resin is in contact with the lower magnetic substrate.

7. The multilayer coil component according to claim 1, wherein
when the surface facing to the laminating direction of the outer surface of the multilayer body is an upper surface, an opening area of the through-hole at the upper surface is from 8% to 11% with respect to an area obtained by adding an area of the upper surface and the opening area.

8. The multilayer coil component according to claim 2, wherein
the accommodation space opens on a through-hole side and does not open on a magnetic substrate side.

9. The multilayer coil component according to claim 3, wherein
the accommodation space opens on a through-hole side and does not open on a magnetic substrate side.

10. The multilayer coil component according to claim 2, wherein
the accommodation space penetrates the adhesive resin layer in the laminating direction.

11. The multilayer coil component according to claim 3, wherein
the accommodation space penetrates the adhesive resin layer in the laminating direction.

12. The multilayer coil component according to claim 2, wherein
the magnetic substrate is an upper magnetic substrate, and
the multilayer coil component further comprises a lower magnetic substrate which is on an opposite side from the laminating direction with respect to the multilayer body,
wherein the magnetic resin is in contact with the lower magnetic substrate.

13. The multilayer coil component according to claim 3, wherein
the magnetic substrate is an upper magnetic substrate, and
the multilayer coil component further comprises a lower magnetic substrate which is on an opposite side from the laminating direction with respect to the multilayer body,
wherein the magnetic resin is in contact with the lower magnetic substrate.

14. The multilayer coil component according to claim 4, wherein
the magnetic substrate is an upper magnetic substrate, and
the multilayer coil component further comprises a lower magnetic substrate which is on an opposite side from the laminating direction with respect to the multilayer body,
wherein the magnetic resin is in contact with the lower magnetic substrate.

15. The multilayer coil component according to claim 5, wherein
the magnetic substrate is an upper magnetic substrate, and
the multilayer coil component further comprises a lower magnetic substrate which is on an opposite side from the laminating direction with respect to the multilayer body,
wherein the magnetic resin is in contact with the lower magnetic substrate.

16. The multilayer coil component according to claim 2, wherein
when the surface facing to the laminating direction of the outer surface of the multilayer body is an upper surface, an opening area of the through-hole at the upper surface is from 8% to 11% with respect to an area obtained by adding an area of the upper surface and the opening area.

17. The multilayer coil component according to claim 3, wherein
when the surface facing to the laminating direction of the outer surface of the multilayer body is an upper surface, an opening area of the through-hole at the upper surface is from 8% to 11% with respect to an area obtained by adding an area of the upper surface and the opening area.

18. The multilayer coil component according to claim 4, wherein
when the surface facing to the laminating direction of the outer surface of the multilayer body is an upper surface, an opening area of the through-hole at the upper surface is from 8% to 11% with respect to an area obtained by adding an area of the upper surface and the opening area.

19. The multilayer coil component according to claim 5, wherein
when the surface facing to the laminating direction of the outer surface of the multilayer body is an upper surface, an opening area of the through-hole at the upper surface is from 8% to 11% with respect to an area obtained by adding an area of the upper surface and the opening area.

20. The multilayer coil component according to claim 6, wherein
when the surface facing to the laminating direction of the outer surface of the multilayer body is an upper surface, an opening area of the through-hole at the upper surface is from 8% to 11% with respect to an area obtained by adding an area of the upper surface and the opening area.
